(19) United States
(12) Patent Application Publication
(10) Pub. No.: US 2013/0285882 A1
(43) Pub. Date: Oct. 31, 2013

(54) MECHANISM FOR FACILITATING A TABLET BLOCK OF A NUMBER OF TABLET COMPUTING DEVICES

(71) Applicants: Minghao Jiang, Shanghai (CN); Mei Yeen Ng, Penang (MY); Timothy Kheng Kool Lim, Penang (MY); Kwee Chin Toe, Johor (MY)

(72) Inventors: Minghao Jiang, Shanghai (CN); Mei Yeen Ng, Penang (MY); Timothy Kheng Kool Lim, Penang (MY); Kwee Chin Toe, Johor (MY)

(21) Appl. No.: 13/977,677

(22) PCT Filed: Dec. 21, 2011
(86) PCT No.: PCT/CN2011/002144

§ 371 Date: Jun. 29, 2013

(51) Int. Cl. G06F 3/14

(52) U.S. Cl. CPC G06F 3/1446
USPC 345/1.3

(57) ABSTRACT

A mechanism is described for facilitating a tablet block of a number of tablet computing devices. A method of embodiments of the invention includes monitoring a connection between a plurality of tablet computers. The monitoring includes detecting user inputs relating to one or more software applications running on the plurality of tablet computers, the user inputs being made via one or more of the plurality of tablet computers. The method may further include dynamically adjusting, in real-time, parameters of the connection based on the user inputs, and displaying changing contents of the one or more software applications, via a shared display screen provided by two or more of the plurality of tablet computers, based on the adjustment of the parameters. The contents are changed in response to an adjustment made to a parameter.

### FIELD

The field relates generally to computing devices and, more particularly, to employing a mechanism for facilitating a tablet block of a number of tablet computing devices.

### BACKGROUND

Several attempts have been made to extend display devices to have greater displays for the user's viewing pleasure. For example, in some cases, separate hardware (e.g., additional display monitors, projectors, etc.) may be used to display large pictures. In some cases, online-based applications may be used to allow multiple users to draw on a same page on a computer device. These conventional techniques are costly (e.g., buying extra hardware, such as display monitors, projectors, screens, etc.) and extremely limited in their scope (e.g., online-based applications) and interactivity (e.g., providing only a single point of user input), etc.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates a computing device employing a block mechanism according to one embodiment of the invention;

FIG. 2 illustrates a number of tablets connected into a tablet block according to one embodiment of the invention;

FIG. 3 illustrates a method for facilitating a tablet block of multiple tablet computing devices according to one embodiment of the invention;

FIGS. 4A-4H illustrate examples of various use cases of tablet blocks according to some embodiments of the invention; and

FIG. 5 illustrates a computing system according to one embodiment of the invention.

### DETAILED DESCRIPTION

Embodiments of the invention provide a mechanism for facilitating a tablet block of a number of tablet computing devices. A method of embodiments of the invention includes monitoring a connection between a plurality of tablet computers. The monitoring includes detecting user inputs relating to one or more software applications running on the plurality of tablet computers, the user inputs being made via one or more of the plurality of tablet computers. The method may further include dynamically adjusting, in real-time, parameters of the connection based on the user inputs, and displaying changing contents of the one or more software applications, via a shared display screen provided by two or more of the plurality of tablet computers, based on the adjustment of the parameters. The contents are changed in response to an adjustment made to a parameter.

In one embodiment, a tablet block is facilitated by connecting two or more tablet computers together using a number of connectors (e.g., Thunderbolt connectors) and a block mechanism to facilitate and manage the tablet block. This provides a cost-effective, easy, and efficient way to merge and form a larger display for a better viewing pleasure for users. In one embodiment, the tablet block can be changed and reformed dynamically, in runtime, with the changing user inputs (that can be provided through each tablet in the tablet block) and requirements and preferences of one or more software applications (e.g., a video game, a movie, etc.) running on the tablets connected in the tablet block. Current solutions provide for a single computing device connected with a number of LCD screens or a projector that takes into account a single point of user input at a time without accepting any form of interactivity from other devices. In one embodiment, each tablet connected in the tablet block is open to user inputs for changing parameters. Further, any one or more of the tablets can be removed from the tablet block and similarly, any number of tablets can be added to an existing tablet block. These input or changes are taken into account by a host tablet of the tablet block which makes any changes to the existing parameters of the tablet block, dynamically and in runtime, as it deems necessary and appropriate.

Embodiments of the invention provide for extending the tablet block's usage model with increased levels of flexibility and form new ways of interaction between the end-user and the tablet devices. Further, it opens up a big innovation space for the next generation's interactive software applications, games, movies, and the like. This way, users are able to experience a higher level of interactivity, flexibility, and display or presentation options. Embodiments of the invention provide for novel features to enable tablets that are physically put together on-the-fly using a number of connectors coupled with the ability to identify the form orientation from the connected tablet devices. The tablet formation's host tablet determines and controls the content that is to be displayed on each of the tablets connected when they are all assembled together. Another novel feature includes managing and controlling multiple user inputs interacting in a single software application session where the display is made up of adjoining screens formed by the combination of tablets.

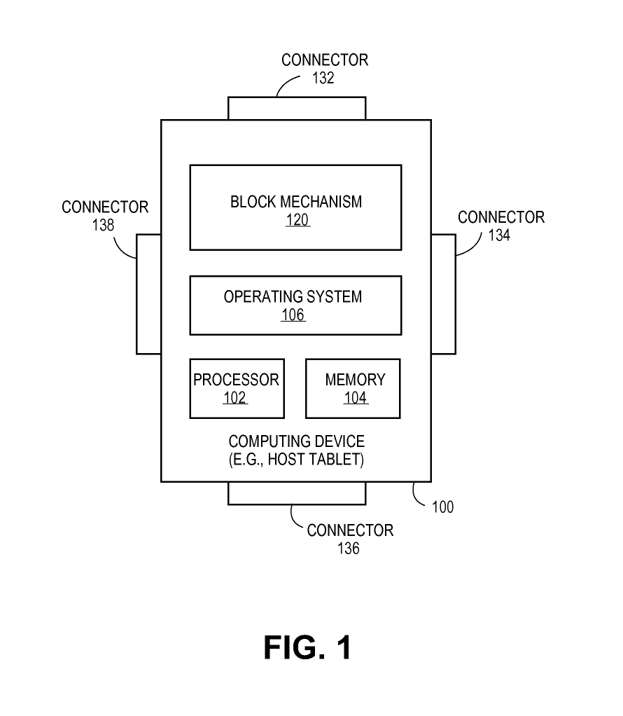

FIG. 1 illustrates a computing device employing a block mechanism according to one embodiment of the invention. In one embodiment, a computing device 100 (e.g., tablet computer or simply referred to as “tablet”) is illustrated as having a block mechanism 120 to facilitate blocking or connecting of various tablet computers. A tablet refers to a mobile computing device that is typically larger than a handheld device (e.g., mobile phone, personal digital assistant (PDA), etc.) having a flat touch screen that uses an onscreen virtual keyboard or a digital pen, etc. Some tablets may be applied to their corresponding convertible notebook computers having swivel or slide joints, etc. Examples of well-known tablets include Apple® iPad®, Samsung® Galaxy Tab®, Lenovo® X61, and the like.

The illustrated tablet 100 includes an operating system 106 serving as an interface between any hardware or physical resources of the tablet 100 and a user. The tablet 100 may further include a processor 102, memory devices 104, network devices, drivers, or the like. It is to be noted that terms like “machine”, “device”, “computing device”, “computer”, “computing system”, “tablet”, and “tablet computer” are used interchangeably and synonymously throughout this document.

In one embodiment, the tablet 100 further includes a block mechanism 120 that is used to connect or block together a number of tablets for various viewing purposes, such as playing games, watching movies, etc. It is contemplated that each tablet that is connected in a block may have the same block mechanism 120 but most of its components may be used by the tablet that is voted as the host tablet, such as the tablet 100 illustrated here. This will be further described with reference to the subsequent figures in this document. Table 100 further includes a number of connectors 132-138 (e.g., Thunderbolt connectors or interfaces that are also known as Light Peak) on any number of sides (e.g., on each of the four sides as illustrated here) to facilitate connection with other tablets. It is contemplated that not all sides may have a connector and that a tablet may not necessarily have four sides, such as a tablet be triangular in shape. It is further contemplated that any type and make of connectors may be employed and that the embodiments are not limited to Thunderbolt connectors.

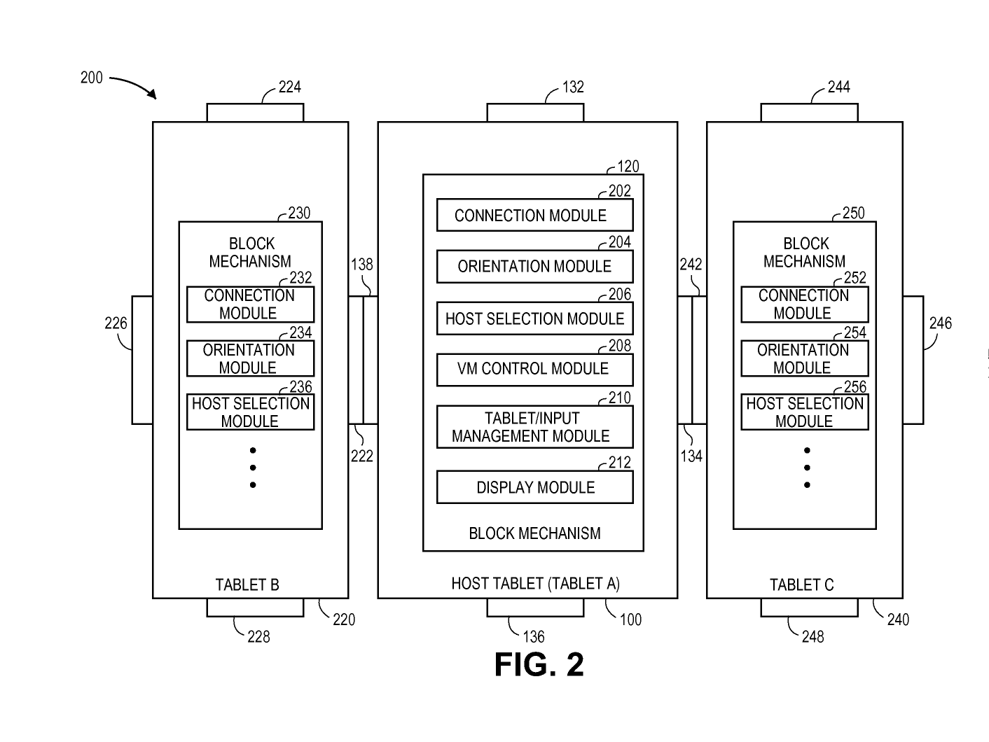

FIG. 2 illustrates a number of tablets connected into a tablet block according to one embodiment of the invention. In one embodiment, tablets A 100, B 220, and C 240 are connected together into a tablet block 200 to represent a wider screen ranging the left most side of tablet B 220 to the right most side of tablet C 240. This block 200 may be used to play games, watch movies, etc. In one embodiment, each tablet 100, 220, 240 may include a block mechanism 230, 120, 250 having various components to facilitate the tablet block 200 and perform its functions. In the illustrated embodiment, tablet A 100 is shown as the one chosen as a host tablet and only its block mechanism 120 is shown in greater detail. However, as aforementioned, each tablet 100, 220, 240 employs a block mechanism 230, 120, 250 having similar or the same components 202-212 as the block mechanism 120 of tablet A 100, such as components 232-236 of tablet B 220 and components 252-256 of tablet C 240.

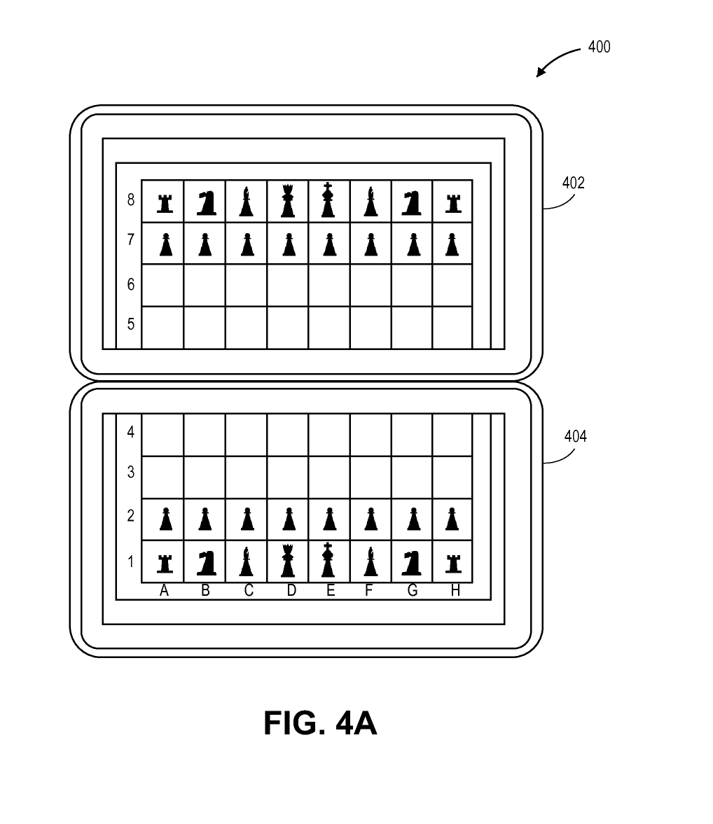

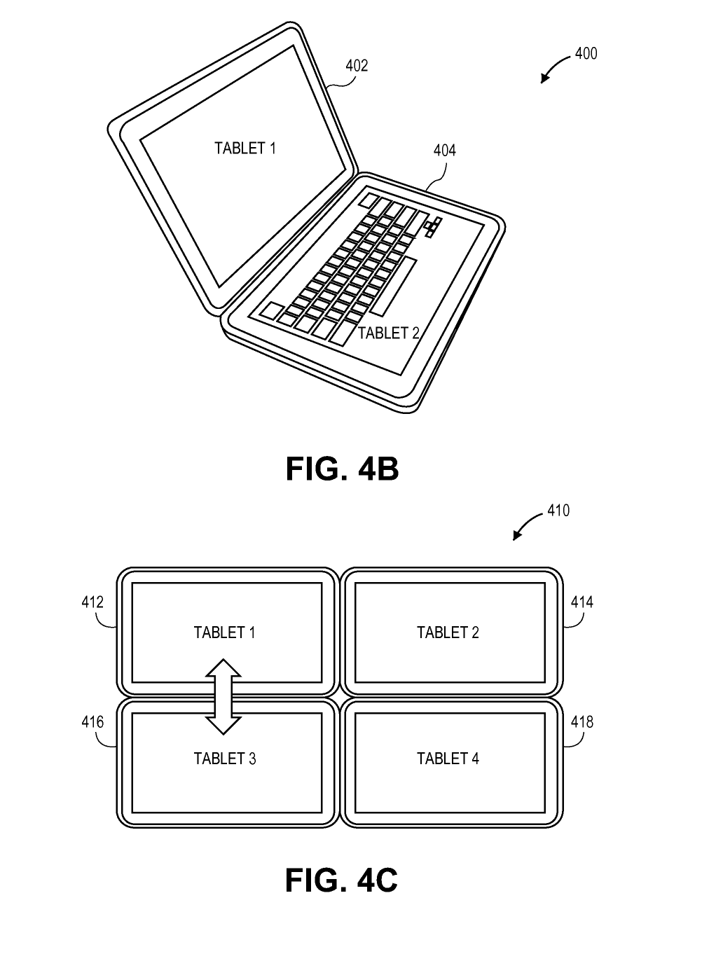

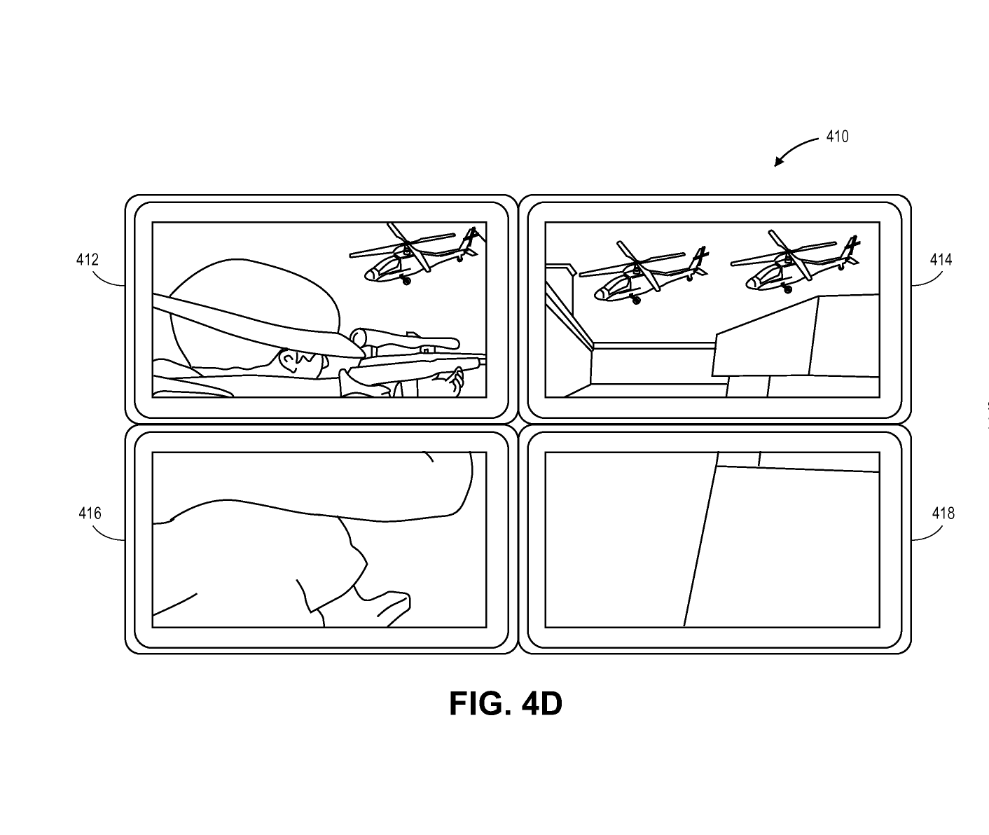

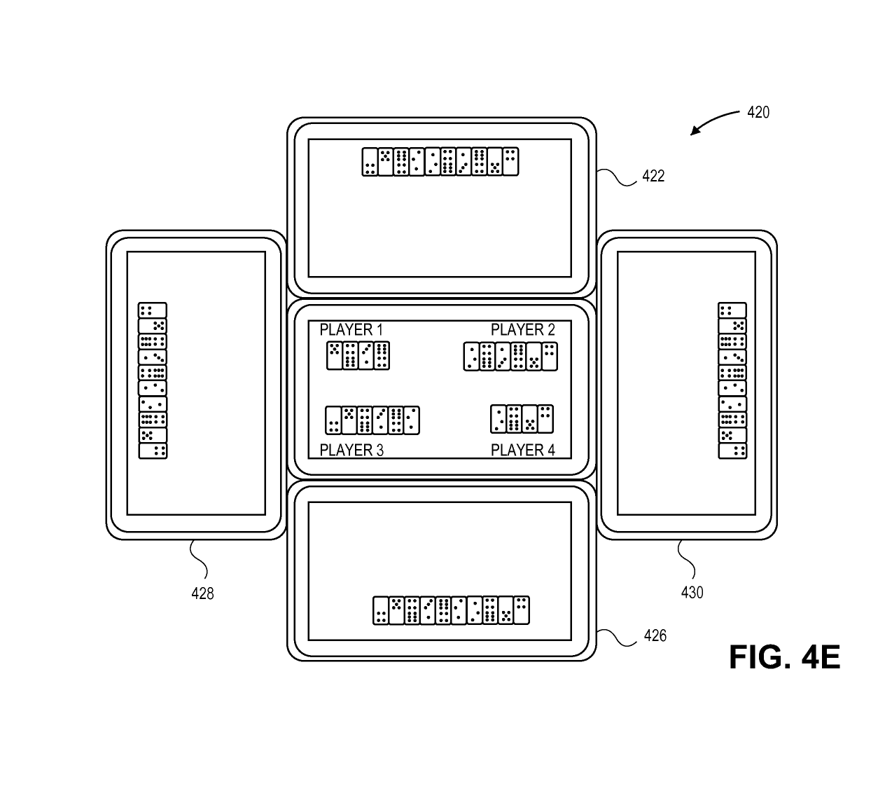

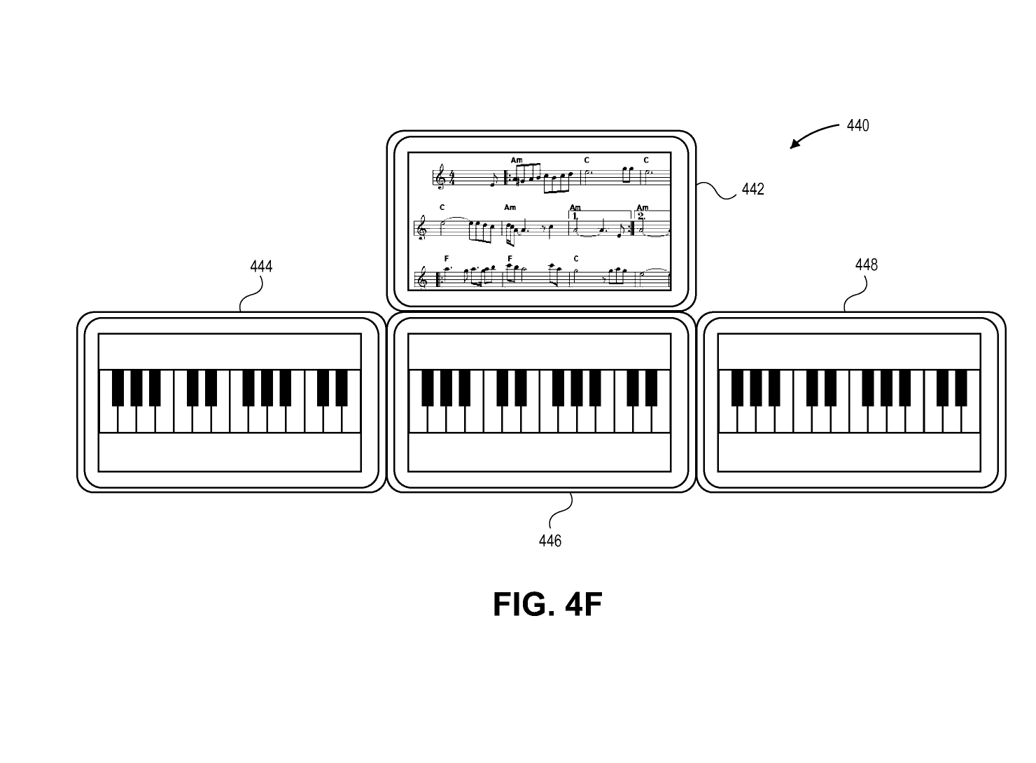

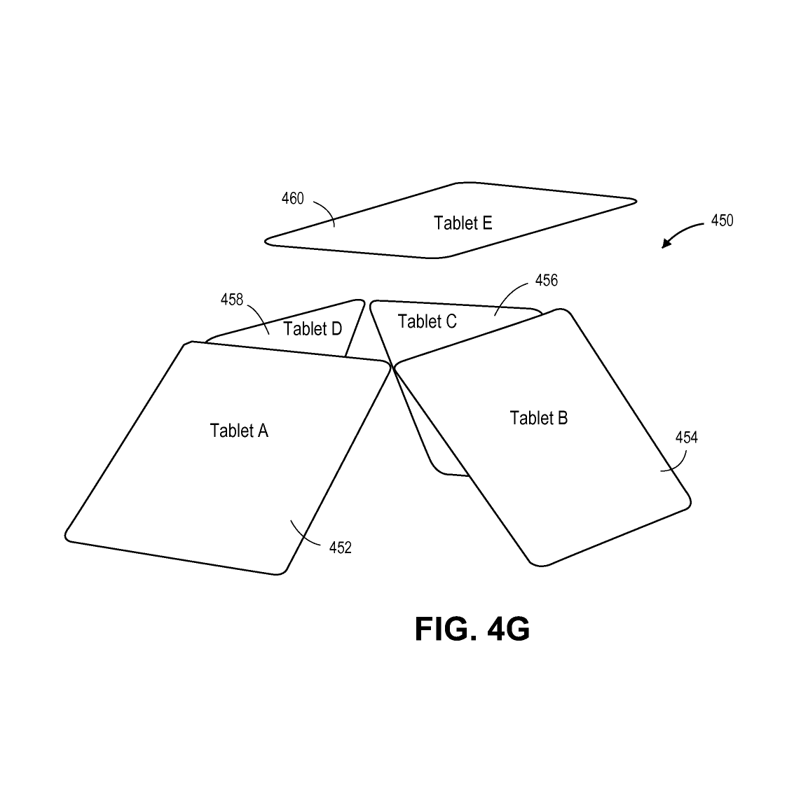

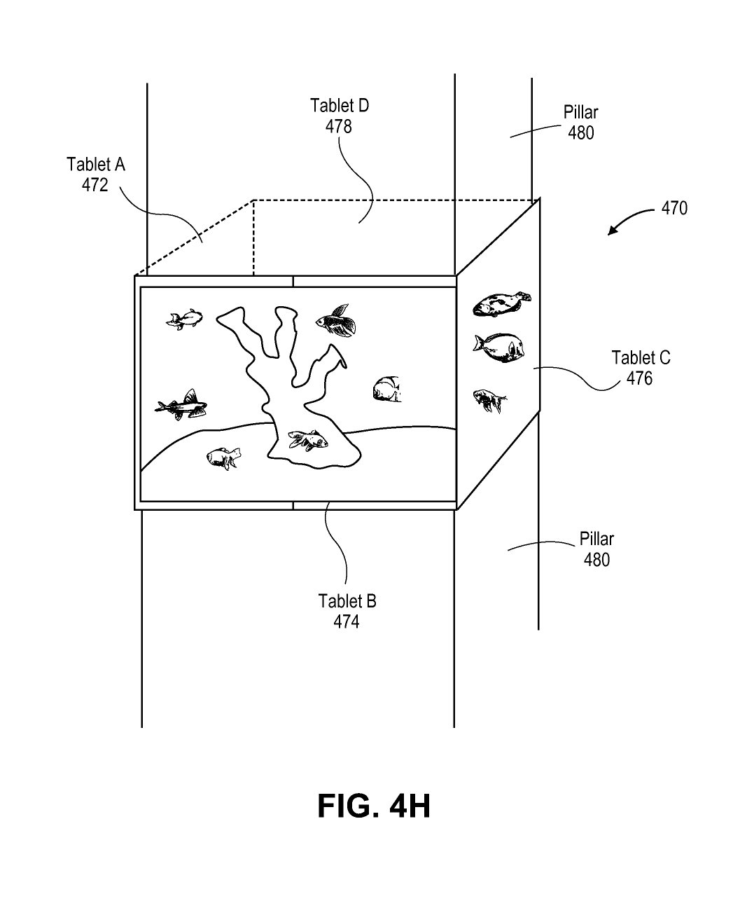

Furthermore, each tablet 100, 220, 240 may have one or more connectors 132-138, 222-228, 242-248 (e.g., Thunderbolt connectors) connected to its one or more sides for serving as interfaces for connecting and communicating with other tablets. For example, in the illustrated embodiment, connectors 134 and 138 of tablet A 100 are connected with connector 222 of tablet B 220 and connector 242 of tablet C 240, respectively. Although, in the illustrated embodiment, four connectors 132-138, 222-228, 242-248 are shown as strategically located on all four sides (e.g., top, bottom, left, and right) of each tablet 100, 220, 240, it is contemplated not all four sides may employ a connector or that a tablet may not be square or rectangular in shape and thus it may not necessarily have four sides (e.g., a tablet may be in triangular or circular in shape or the like). Further, although, three tablets A 100, B 220, and C 240 are shown here as connected in a tablet block 200, this block 200 form and the number and the type of tablets 100, 220, 240 are merely used as an example for brevity, clarity, and ease of understanding and that it is contemplated that any number and type of tablets may be connected in together to form a tablet block or any shape or form and that embodiments of the invention are not limited to the illustrated embodiment. For example, the tablets A 100, B 220, C 240 may be connected such that any one or more of the three tablets 100, 220, 240 may be tilted (as referenced in FIG. 4G) in any direction (up, down, right, left, etc.) so that the block 200 is not limited to merely a flat block as illustrated here.

In one embodiment, once the three tablets 100, 220, 240 are physically connected using the connectors 138, 222, 134, 242, connection modules 202, 232, 252 of the three block mechanisms 120, 230, 250 communicate with each other to recognize and accept the physical connection between their respective tablets A 100, B 220, C 240. For example, as illustrated, three tablets 120, 220, 240 are connected together (using connectors 138, 222, 134, 142) to form a tablet block 200 which may then serve as a big display screen (comprising the three screens of the three tablets 100, 220, 240) and a large interactive workspace to provide a much better user experience than any one of the tablets 100, 220, 240 could offer. In this case, the connection modules 202, 232, 252 are used to recognize the connection between the three tablets 100, 220, 240 and facilitate any necessary adjustment so the tablets 100, 220, 240 may have proper physical positioning and data communication layer. In one embodiment, the connection modules 202, 232, 252 detect the exact connector that is connected to the other adjoining tablet (e.g., connector 138 connected with connector 222, etc.) and work with orientation modules 204, 234, 254 to identify the physical orientation of the adjoining tablets (such as tablets B 220 and C 240 are to tablet A 100) and enable the primary or host tablet (such as tablet A 100) to summarize its connection information and map the topography.

In one embodiment, the orientation modules 204, 234, 254 of the three block mechanisms 120, 230, 240 may be used to perform the physical orientation and analysis of each tablet 120, 230, 240 with respect to their display capabilities, screen size, memory size, processor capabilities, tablet speed, each tablet's network speed, network capacity or bandwidth, etc. Once the block 200 is regarded as valid, the information analyzed by the orientation modules 204, 234, 254 is then provide to the respective host selection modules 206, 236, 256.

Host selection modules 206, 236, 256 communicate with each other to determine which of the three tablets 100, 220, 240 ought to be the host tablet. In making this decision, the host selection modules 206, 236, 256 take into consideration the information gathered by the orientation modules 204, 234, 254, such as the speed (e.g., processor speed) of each tablet 100, 220, 240, network speed of each tablet's host network, etc. In one embodiment, the fastest of the three tablets 100, 220, 240 is chosen to be the host tablet, such as tablet A 100 in the illustrated embodiment. In some embodiments, factors other than the speed of the tablets 100, 220, 240 (e.g., memory size, physical location, etc.) may be taken into consideration and be the determining factor in choosing a host tablet. In yet some other embodiments, the user may overrule any and all determining factors and simply manually choose one of the tablets 100, 220, 240 to serve as the host tablet.

Once the host tablet A 100 is determined and chosen (e.g., automatically by the host selection modules 206, 236, 256 or manually by the user), the host tablet 100 may assume some unique responsibilities and may even take some of the tasks of other tablets 220, 240. For example, the host tablet 100 may be responsible for coordinating the three tablets 100, 220, 240, such as coordinating communication, sharing information, adjusting displays, managing and controlling user inputs that are made by users using their corresponding tablets 100, 220, 240, and the like. In one embodiment, the host tablet 100, using the virtual machine (“VM”) control module 208, may trigger one or more VMs (e.g., Java VM, Parrot VM, Common Language Runtime (“CLR”), etc.) to start up one or more VM sessions to, for example, control the tablets 100, 220, 240 in running any number of software applications (e.g., video games, movies, business applications (e.g., Word®, Excel®, Pages®, etc.), social network applications (e.g., Facebook®, LinkedIn®, etc.), or the like. Running these applications includes managing the applications within the tablet block 200 by, for example, communicating and managing appropriate data between the tablets 100, 220, 240, continuously adjusting the three tablets' surface or display area to show the appropriate size of user interface of the software application that is being run on the tablets 100, 220, 240, and the like. It is contemplated that other tablets 220, 240 in the block 200 may have their own corresponding VM control modules.

Furthermore, the host tablet's VM control module 208 works with VM control modules of other tablets 220, 240 as well as with tablet input management modules (“management modules”) (such as management module 210 of host tablet A 100) to manage and control user inputs that may be received at and from any of the tablets 100, 220, 240 connected in the block 200. In one embodiment, if a user of tablet B 220 performs an input (using, for example, a touchscreen, a keyboard, a mouse, camera, printer, etc.) to add, delete, or change information, that user input is received at tablet B 220 and then communicated on to the host tablet A 100 where it is processed and analyzed by one or more various modules (depending on the nature of the input) of the block mechanism 120 to adjust the connection and relevant communication between the three tablets 100, 220, 240. For example, the user may simply change the color of the background on tablet B 220 which is assessed and processed by one or more of the modules of the block mechanism 120 and the request may simply be taken care of by the block mechanism 220 of tablet B 220 and be communicated on to the block mechanism 120 of the host tablet 100. Now, let us suppose, the user disconnects tablet B 220 from the tablet block 200. Since an input or request of this type can change the entire orientation of the block 200, the request is processed by block mechanism 230 and then communicated on to block mechanism 120 (and to block mechanism 250) for further processing and decision-making (e.g., connection and orientation modules 202-204, 252-254 may re-gather and re-evaluate the existing connections and relevant information for the remaining tablets A 100 and C 240).

Block mechanisms 120, 230, 250 may each include a display module, such as display module 212 of block mechanism 120. In the illustrated embodiment, the display module 212 at the host tablet 100 works with display modules of other block mechanisms 220, 240 and the other modules 202-210 of block mechanism 120 to ensure a proper display covering the three tablets 100, 220, 240. For example, the display module 212 works with the VM control module 208 and the management module 210 to continuously adjust and re-align the display based on the changing information and the nature of the software application (e.g., a movie that constantly changes scenery and colors, etc.) and/or the detected user input.

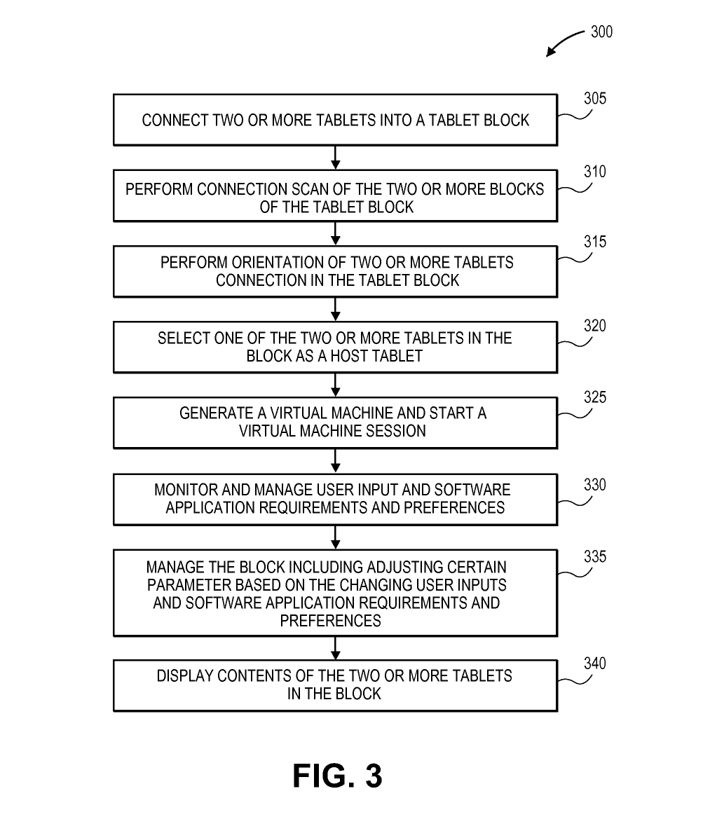

FIG. 3 illustrates a method for facilitating a tablet block of multiple tablet computing devices according to one embodiment of the invention. Method 300 may be performed by processing logic that may comprise hardware (e.g., circuitry, dedicated logic, programmable logic, etc.), software (such as instructions run on a processing device), or a combination thereof. In one embodiment, method 300 is performed by block mechanism 120 FIG. 1.

Method 300 starts at processing block 305 with connecting two or more tablet computing devices into a tablet block. Since details of the workings of various components of a block mechanism are provided in FIG. 2, for brevity, most of those details will not be repeated here with reference to FIG. 3. At processing block 310, as described with reference to FIG. 2, a connection scan of the two or more tablets connected in the tablet block is performed. This connection scan may include detecting and adjusting connectors that are used to connect the tablet block's two or more tablets. At processing block 315, orientation of the two or more tablets of the block is performed. Again, as described with reference to FIG. 2, orientation may include gathering and analyzing data pertinent to the two or more tablets, such as each tablet's processor speed, network speed, memory size, display size, etc.

At processing block 320, in one embodiment, the gathered and analyzed data is further processed to select one tablet of the two or more tablets in the tablet block as a host tablet. In one embodiment, the host tablet may be chosen based on tablet processor or network speed, tablet processor or memory or network capacity or bandwidth, etc. In another embodiment, a user may manually choose a tablet to serve as the host tablet. At processing block 325, the selected host tablet then triggers a virtual machine to start a virtual machine session. The virtual session is used with various components of the block mechanism (as detailed with reference to FIG. 2) to perform a number of management and control of various tasks and relevant information to facilitate and performs functions of the tablet block.

At processing block 330, user inputs (e.g., setting changes proposed by the user using a touchscreen, keyboard, mouse, etc., of two or more tablets of the block) and various requirements and preference of one or more software applications being run on the two or more tablets are continuously monitored and managed to perform proper management of the connection and operations of the tablet block by, for example, continually adjusting, as necessitated, certain parameters of the tablet block (e.g., display) based on the changing user inputs and requirements and parameters of the one or more software applications at processing block 335. At processing block 340, contents of the two or more tablets of the tablet block are displayed by the connected display screens of the two or more tablets.

FIGS. 4A-4H illustrate examples of various use cases of tablet blocks according to some embodiments of the invention. In one embodiment, FIG. 4A illustrates a table block 400 having two tablet computing devices 402, 404 that are connected together to form the table block 400. In the illustrated embodiment, the two tablets 402, 404 are connected together to form a larger display area to, for example, play chess. This larger display area of the block 400 provides a more comfortable feel and a larger play area than can be offered by a single tablet. FIG. 4B illustrates the same tablet block 400 in a different use case where the tablets 402, 404 are connected together to form a foldable block 400 like a laptop computer.

Referring now to FIG. 4C, four tablets 412-418 are shown as connected in a four-tablet block 410 were each of the four tablets 412-418 uses its block mechanism (e.g., connection and orientation modules) to identify the physical position of the other three tablets and calculate the topography based on the connection. For example, tablet 1 412 has its right connector port (e.g., Thunderbolt connector) connected to the left connector port of tablet 2 414, while its bottom connector is connected to the top connector of tablet 3 416. Similarly, the right connector of tablet 3 416 connects to the left connector of tablet 4 418, while the top connector of the tablet 4 418 connects to the bottom connector of the tablet 2 414. This technique can be used to form an n*m use case, as illustrated in FIG. 4D, that enables the tablet block 410 to form a large screen to display, for example, a movie. For example, a number of users can decide on the fly to join their tablets 412-418 together to form a large screen tablet block 410 to watch a movie or the like. Further the tablet block 410 can be hung on a wall (using each tablet's hanging ability) for an even better theater-like viewing.

FIG. 4E illustrates another use case scenario where five tablets 422-430 are connected together to form a tablet block 420. A tablet block 420 of this nature can be used for performing activity that may require four users, such as playing mahjong, arcade, strategy, dominos, or the like.

FIG. 4F illustrates another use case where four tablets 442-448 are connected together to form a tablet block 440 such that the bottom three tablets 444-448 form a keyboard while the top tablet 442 serves to display a music sheet. For example, a tablet like an iPad® does not offer a screen big or wide enough to fit the full standard keyboard which limits the user to an overlapping keyboard exposing only a small part of the keyboard at a time that can significantly constrain the user experience. In one embodiment, by assembling several tablets 444-448 together, as illustrated here, a standard keyboard can be displayed to be used by the user. An additional tablet 442 may then be assembled to show music notes on a music sheet.

FIG. 4G illustrates yet another use case scenario where five tablets A-E 452-460 are connected together to form a tablet block 450 such that, in one embodiment, any number of tablets A-E 452-460 may be slanted to form a particular shape of the tablet block 450. For example, in the illustrated embodiment, tablets A-D 452-458 are shown as slanted to form a pyramid-like shape of the tablet block 450 where tablet E 460 is shown as capable of being connected to the four slanted tablets A-D 452-458 to top the pyramid block 450.

FIG. 4H illustrates another use case scenario where four tablets A-D 472-478 are shown as connected together and around a pillar 480 (e.g., concrete pillar, wood pillar, etc.) to form, for example, a view of an aquarium to add to the ambiance of a particular place (e.g., a restaurant, a doctor office, a children's play area, a residence, etc.). It is contemplated that the embodiments of the invention are not limited to the number of tablets illustrated here or with respect to any of the other Figures throughout this document and that a user may use any number of tablets to perform a variety of tasks or activities. For example, a user may employ five tablets instead of the three tablets 444-448 illustrated here to form a standard keyboard or that the user may not use any tablets or use two or more tablets (such as connecting one tablet on top of tablet 446) to form display a music sheet or any other relevant or irrelevant information.

It is further contemplated that none of the user scenarios or combinations illustrated throughout this document are limited to playing video games or instruments or watching movies and that any number and type of other tasks, activities, functions, and uses (e.g., government officials working on a city budget, lawyers working on a pending lawsuit, doctors reviewing a patient's x-rays, etc.) can be performed with greater efficiency using various tablets connected in a tablet block than having each user working on his or her own individual tablet. It is further contemplated that any type of tablets can be connected together. For example, the embodiments provide for the connectivity and compatibility between one or more iPads® and one or more Samsung® Galaxy Tabs® and further with one or more Hewlett Packard® Compaq® tab, and the like, to form a tablet block.

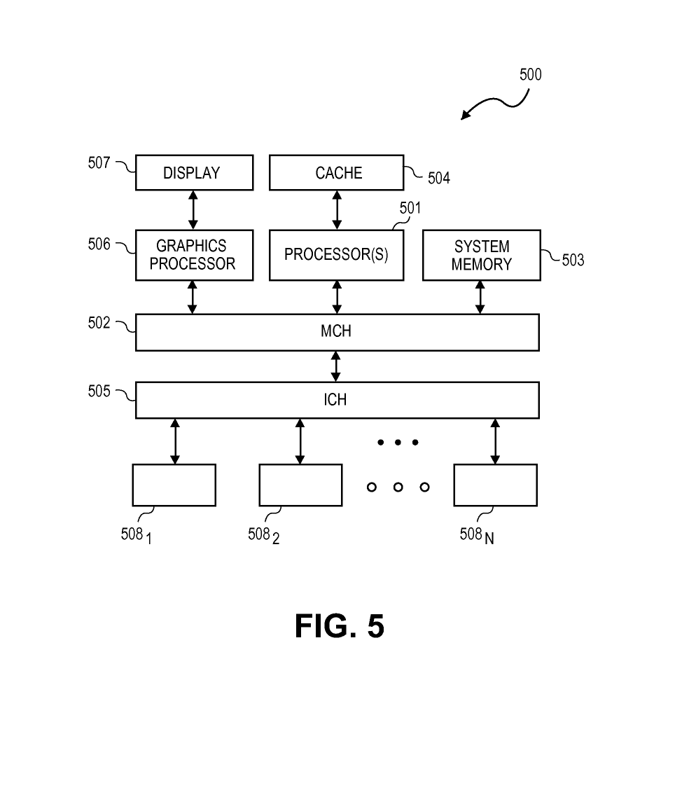

FIG. 5 illustrates a computing system 500 representing a tablet computing device capable of employing a block mechanism 120 as referenced in FIG. 1 according to one embodiment of the invention. The exemplary computing system of FIG. 5 includes: 1) one or more processors 501 at least one of which may include features described above; 2) a memory control hub (MCH) 502; 3) a system memory 503 (of which different types exist such as double data rate RAM (DDR RAM), extended data output RAM (EDO RAM) etc.); 4) a cache 504; 5) an input/output (I/O) control hub (ICH) 505; 6) a graphics processor 506; 7) a display/screen 507 (of which different types exist such as Cathode Ray Tube (CRT), Thin Film Transistor (TFT), Light Emitting Diode (LED), Molecular Organic LED (MOLED), Liquid Crystal Display (LCD), Digital Light Projector (DLP), etc.; and 8) one or more I/O devices 508.

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster static RAM (SRAM) cells whilst system memory 503 might be constructed with slower dynamic RAM (DRAM) cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, Local Area Network (LAN) port, modem port, etc.) or retrieved from an internal storage element of the computer system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The ICH 505 is responsible for ensuring that such data is properly passed between the system memory 503 and its appropriate corresponding computing system interface (and internal storage device if the computing system is so designed). The MCH 502 is responsible for managing the various contending requests for system memory 503 accesses amongst the processor(s) 501, interfaces and internal storage elements that may proximately arise in time with respect to one another.

One or more I/O devices 508 are also implemented in a typical computing system. I/O devices generally are responsible for transferring data to and/or from the computing system (e.g., a networking adapter); or, for large scale non-volatile storage within the computing system (e.g., hard disk drive). ICH 505 has bi-directional point-to-point links between itself and the observed I/O devices 508.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

1. A computer-implemented method comprising:
monitoring a connection between a plurality of tablet computers, wherein monitoring comprises detecting user inputs relating to one or more software applications running on the plurality of tablet computers, the user inputs being made via one or more of the plurality of tablet computers;
dynamically adjusting, in real-time, parameters of the connection based on the user inputs; and
displaying changing contents of the one or more software applications, via a shared display screen provided by two or more of the plurality of tablet computers, based on the adjustment of the parameters, wherein the contents are changed in response to an adjustment made to a parameter.

2. The computer-implemented method of claim 1, wherein monitoring further comprises detecting changing preferences of the one or more software applications.

3. The computer-implemented method of claim 2, further comprising adjusting, in real-time, the parameters of the connection based on the changing preferences of the one or more software applications.

4. The computer-implemented method of claim 1, further comprising selecting a tablet computer of the plurality of tablet computers to serve as a host tablet computer to perform administrative tasks relating to the connection, wherein the administrative tasks comprise one or more of monitoring, dynamic adjusting, and displaying.

5. The computer-implemented method of claim 4, wherein the host tablet computer to facilitate a virtual machine session to perform the administrative tasks.

6. The computer-implemented method of claim 1, wherein the plurality of tablet computers are connected using connectors, wherein a connector is employed on one or more sides of each tablet computer.

7. The computer-implemented method of claim 1, wherein the changed contents are based on user actions and are received by the host tablet computer via one or more of a keyboard, a mouse, and a touchscreen.

8. A system comprising:
a block mechanism for a tablet computer to be connected to one or more other tablet computers, wherein the block mechanism to:
monitor a connection between a plurality of tablet computers, wherein the block mechanism is further to detect user inputs relating to one or more software applications of the plurality of tablet computers, the user inputs being made via one or more of the plurality of tablet computers;
dynamically adjust, in real-time, parameters of the connection based on the user inputs; and
display a change in contents of the one or more software applications, via a shared display screen provided by the tablet block, based on the adjustment of the parameters, wherein the block mechanism is further to change the contents in response to an adjustment to a parameter.

9. The system of claim 8, wherein the block mechanism is further to detect a change in a preference of the one or more software applications.

10. The system of claim 9, wherein the block mechanism is further to adjust, in real-time, the parameters of the connection based on the change in the preference of the one or more software applications.

11. The system of claim 8, wherein the block mechanism is further to select a tablet computer of the plurality of tablet computers to serve as a host tablet computer to perform administrative tasks relating to the connection, wherein the administrative tasks comprise one or more of monitoring, dynamic adjusting, and displaying.

12. The system of claim 11, wherein the host tablet computer to facilitate a virtual machine session to perform the administrative tasks.

13. The system of claim 8, wherein the plurality of tablet computers are connected using connectors, wherein a connector is employed on one or more sides of each tablet computer.

14. The system of claim 8, wherein the change in contents are based on user actions to be received by the host via one or more of a keyboard, a mouse, and a touchscreen.

15. A non-transitory machine-readable medium comprising instructions that, when executed by a machine, cause the machine to:
monitor a connection between a tablet computer and one or more other tablet computers of a plurality of tablet computers, wherein monitoring comprises detecting user inputs relating to one or more software applications running on the plurality of tablet computers, the user inputs being made via one or more of the plurality of tablet computers;
dynamically adjust, in real-time, parameters of the connection based on the user inputs; and
display changing contents of the one or more software applications, via a shared display screen provided by two or more of the plurality of tablet computers, based on the adjustment of the parameters, wherein the contents are changed in response to an adjustment made to a parameter.

16. The non-transitory machine-readable medium of claim 15, wherein monitoring further comprises detecting changing preferences of the one or more software applications.

17. The non-transitory machine-readable medium of claim 16, wherein the machine is further to adjust, in real-time, the parameters of the connection based on the changing preferences of the one or more software applications.

18. The non-transitory machine-readable medium of claim 15, wherein the machine is further to select a tablet computer of the plurality of tablet computers to serve as a host tablet computer to perform administrative tasks relating to the connection, wherein the administrative tasks comprise one or more of monitoring, dynamic adjusting, and displaying.

19. The non-transitory machine-readable medium of claim 18, wherein the host tablet computer to facilitate a virtual machine session to perform the administrative tasks.

20. The non-transitory machine-readable medium of claim 15, wherein the plurality of tablet computers are connected using connectors, wherein a connector is employed on one or more sides of each tablet computer.
